(19) United States
(12) Patent Application Publication
(10) Pub. No.: US 2005/0031437 A1
(43) Pub. Date: Feb. 10, 2005

(54) Roll-off container

(76) Inventor: Lawrence A. Doose, Princeton, MN (US)

Correspondence Address: Schwegman, Lundberg, Woessner & Kluth, P.A., P.O. Box 2938, Minneapolis, MN, 55402, US

(21) Appl. No.: 10/637,381

(22) Filed: Aug. 7, 2003

(51) Int. Cl. B60P 1/00

(52) U.S. Cl. 414/467

(57) ABSTRACT

A transport and dispensing device includes a roll-off container body defined by a base, side walls, and a rear wall. A container support is coupled to the roll-off container body. A front door is coupled to the roll-off container body, and a loading fastener is coupled to an outer surface of the front door. The roll-off container is positioned for unloading of its contents so a rear wall of the container is adjacent a boundary of a location. The front door is then opened to allow access to the container contents.

### TECHNICAL FIELD

The present invention relates generally to roll-off containers. More particularly, it pertains to roll-off containers having a door at the proximal loading end of the container.

### BACKGROUND

Containers of various types are used in numerous applications, including the nursery industry, to transport materials, from one location to another. Additionally, containers are used to store materials, like mulch, flowers, potting soil and saplings, for future use or transport. Vehicles are often employed in transporting the containers and their contents. In one type of vehicle, the container is integral to the vehicle, as is the case with a dump truck having a bucket container. The dump truck carries mulch or garden and lawn products to a retail location for future sale. Alternatively, the dump truck may take the product to another locale, a residential home, for yard usage. In both cases the mulch takes up a large amount of space on the property. A great deal of manpower or equipment is necessary to move the mulch if the occupied space on the property is needed. This is often the case for retailers, like nurseries, where open space on the property comes at a premium.

One solution to the space issue mentioned above is the construction of a bin or walled enclosure to more efficiently hold the mulch. A bin can be expensive to construct and is a semi-permanent fixture on the property. However, a bin is often necessary to retain mulch in an organized manner and save space on property having a limited area. If the property space is needed for another use at a later time the bin must be demolished and removed. Additionally, it is common practice for nurseries and other large retailers that sell lawn and gardening products to keep products (i.e. mulch) on a parking lot surface. Because these products are generally seasonal, a nursery or other general retailer would not want an unused and immobile semi-permanent bin during the off-season when it could otherwise use the additional parking.

In another application, movable containers having a door attempt to solve the space issue created by large mounds of mulch, other garden and yard products (tree saplings, flowers, soil, etc.), as well as semi-permanent bins. These movable containers generally possess doors that lower from a rear wall or a side wall. To position these containers a driver having a vehicle that carries the container must back the container onto small pieces of property. In the case of nurseries, the property is often already crowded with floral displays, yard equipment, saplings and lawn furniture, and it is difficult to maneuver and position containers. Additionally, once a container is positioned, there must also be adequate space to open the container door and easily access the contents. Consequently, a container having side or rear opening doors must be positioned with not only enough space for the container, but also adequate space to open the door and enable user access to the contents.

Accordingly, what is needed is a mobile container that overcomes the shortcomings of previous containers. What is further needed is a mobile container that requires a minimum of space to position and has access means that may be easily accommodated within tight space requirements.

### SUMMARY

A transport and dispensing device, such as a roll-off container, includes a container body defined by a base, side walls, and a rear wall, where a container support is coupled to a lower surface of the roll-off container body. A front door is coupled to the roll-off container body, and a loading fastener is coupled to an outer surface of the door. The loading fastener is provided for moving the device on and off transport vehicles.

Several options for the transport and dispensing device follow. For example, in one option, the container support includes a roller that is coupled to a proximal end of the container body base. In another option, the front door is hingedly coupled to a distal end of the of container body base. In other words, the front door is disposed on an opposite end of the container body from the roller. In yet another option, a ramp is hingedly coupled to the front door of the device. The ramp is coupled at a proximal end of the ramp to a distal end of the front door. The front door of the transport and dispensing device, in another option, has a substantially vertical orientation with respect to the container body base when the door is in a closed position. The ramp has a substantially horizontal orientation with respect to the container body base when the door is in a closed position. In yet another option, when the door is in an open position, the door has a substantially horizontal orientation with respect to the container body base. The ramp has an orientation that is complementary to an orientation of whatever surface the ramp is disposed upon when the front door is in the open position. The transport and dispensing device further includes, in another option, a door actuating mechanism coupled to the container body, the mechanism includes a moveable element extending from the body of the mechanism to a distal end of the ramp, where the moveable element is coupled to the ramp.

In another embodiment, a method comprises lowering a roll-off container from a transport vehicle to a position for unloading the container contents, the roll-off container including a body defined by a base, side walls and a rear wall, a roller coupled to the container body, and a front door coupled to the container body and a loading fastener coupled to the front door. The container is removed from the transport vehicle by a means of lowering coupled to the loading fastener. The method further includes disconnecting the means of lowering the roll-off container from the loading fastener, opening the front door, and accessing the contents inside the container.

Several options for the method follow. In one option, for example, opening the front door further includes lowering the front door from a first, closed position, where the front door has a substantially vertical orientation with respect to the roll-off container body base, to a second, open position where the door has a substantially horizontal orientation with respect to the roll-off container body base. In another option, a ramp, that is hingedly coupled to a distal end of the door along a proximal end of the ramp, is lowered from a substantially vertical position with respect to the roll-off container body base after the front door is lowered to the second, open position. The ramp is lowered into an orientation complementary to an orientation of a surface onto which the ramp is disposed. In yet another option, a door actuator mechanism is operated to lower the front door from the first, closed position to the second open position. The door actuator mechanism is coupled at a first end to a side wall of the roll-off container and coupled at a second end to the ramp. A door fastener is provided in another option where the door fastener is coupled to the front door and operably engaged with a fastening member coupled to the roll-off container body side wall. The door fastener is released from its engagement with the fastening member by operation of the fastening member.

In yet another embodiment, a method comprises positioning a roll-off container at a location for unloading contents from the roll-off container, where a rear wall of the roll-off container is positioned adjacent a boundary of the location. The roll-off container includes a roll-off container body defined by a base, side walls, and the rear wall, a roller coupled to the container body, and a front door coupled to the container body and a loading fastener coupled to the front door. The method further includes opening the front door, and accessing the container contents.

The transport and dispensing device allows for compact transport and storage of lawn and garden products, and allows for access of those products within tight space requirements. The front door assists in positioning the device as a vehicle driver need only position the device within a space adequate for the roll-off container body. Because the device door opens from the front, the direction the vehicle will pull away from the positioned device, the driver does not need to otherwise consider a door when maneuvering the device into position. Additionally, because the door opens from the front end of the container body, the driver may position the device with the rear wall and side walls adjacent the boundary line of a property. The door may then be opened onto the property itself while the container body is adjacent the property boundary lines. Furthermore, being able to move the transport and dispensing device provides easy access to an area of the property that would otherwise be inaccessible with a mound of mulch or other garden products occupying the area. Further still, the transport and dispensing device eliminates the need for separate bins constructed on the property as the device serves transport and storage needs.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE DRAWINGS

FIG. 1 is a first side elevational view illustrating a roll-off container constructed in accordance with one embodiment.

FIG. 2 is a front end view illustrating a roll-off container constructed in accordance with one embodiment.

FIG. 3 is a second side elevational view illustrating a roll-off container constructed in accordance with one embodiment.

FIG. 4 is a third side elevational view illustrating a roll-off container constructed in accordance with one embodiment.

FIG. 5 is a block diagram illustrating one embodiment of a method of use for the roll-off container.

FIG. 6A is a fourth side elevational view illustrating a roll-off container constructed in accordance with one embodiment.

FIG. 6B is a fifth side elevational view illustrating a roll-off container constructed in accordance with one embodiment.

FIG. 7A is a sixth side elevational view illustrating a roll-off container constructed in accordance with one embodiment.

FIG. 7B is a seventh side elevational view illustrating a roll-off container constructed in accordance with one embodiment.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

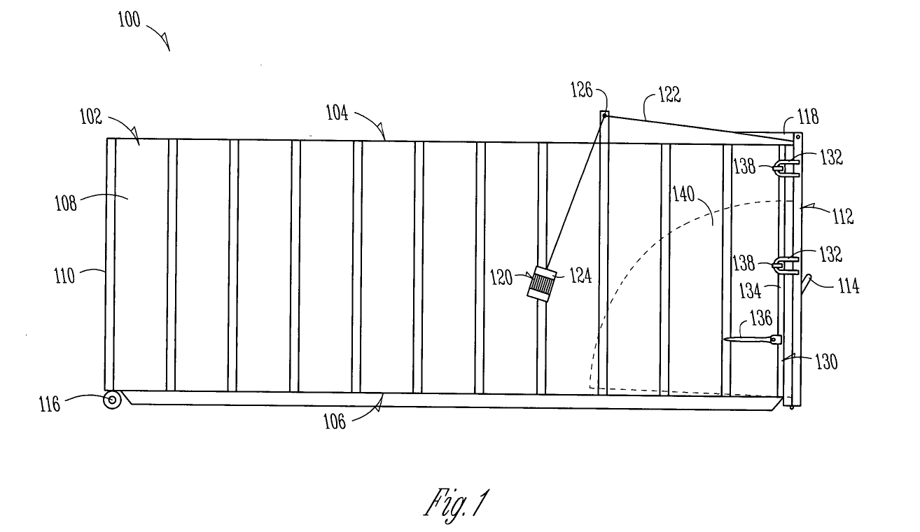

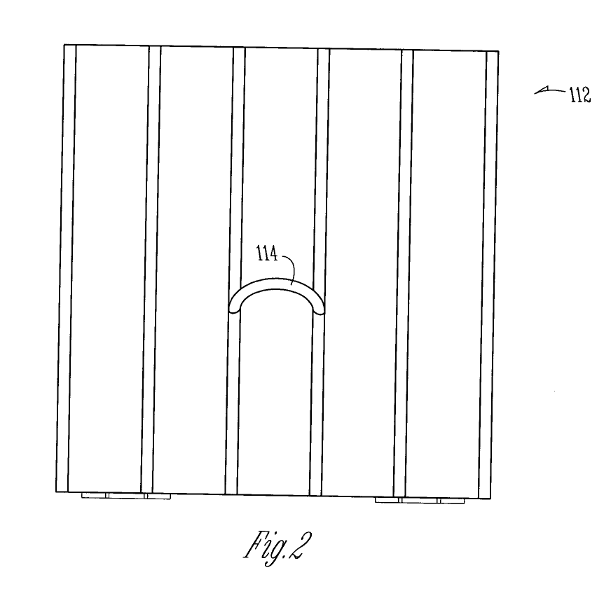

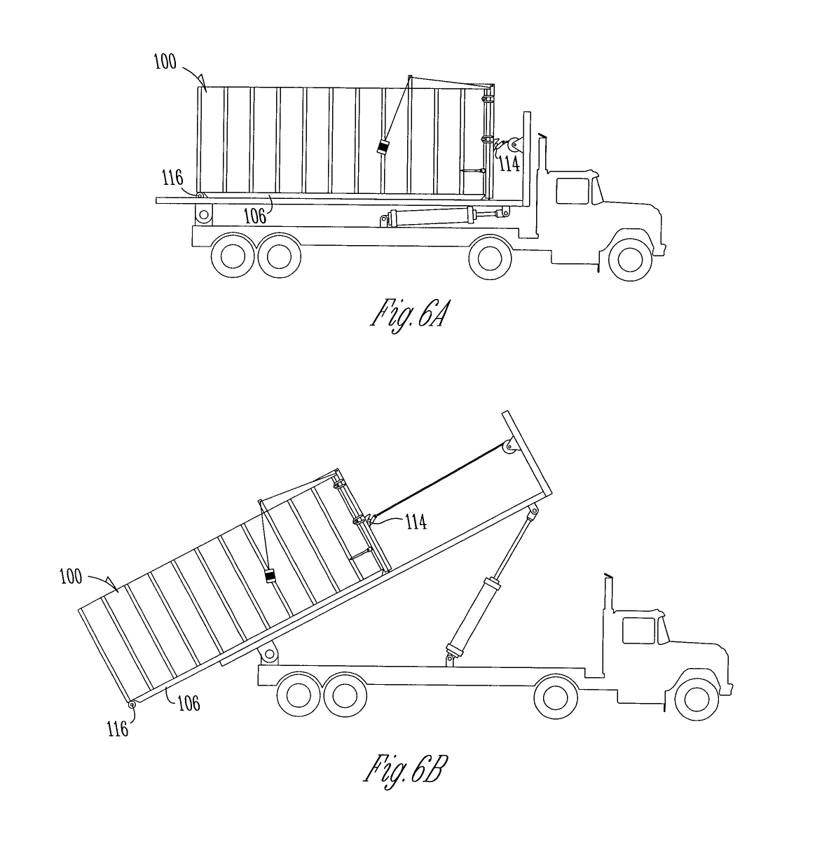

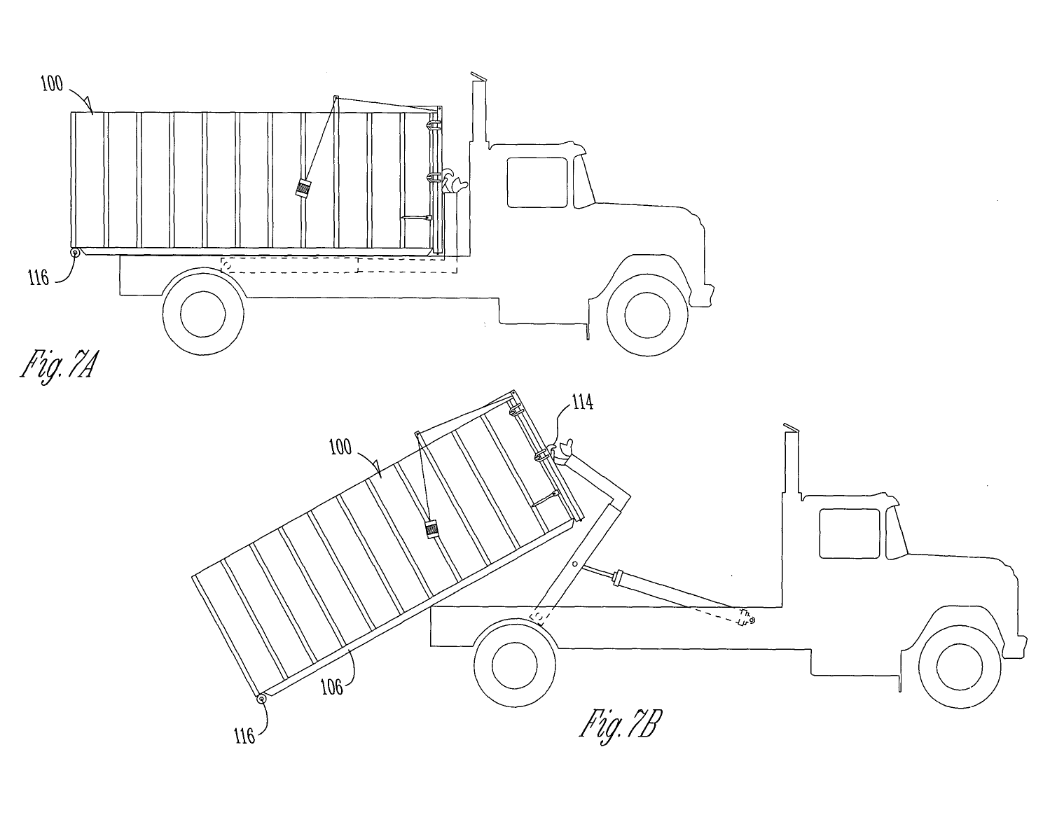

FIG. 1 illustrates a transport and dispensing device 100 comprising a roll-off container 102. The transport and dispensing device 100 includes a roll-off container body 104 having a base 106, side walls 108, and a rear wall 110. As described in greater detail below, a front door 112 is included. The front door 112 is hingedly coupled to a distal end of the base 106 along a proximal end of the door 112. The front door 112 allows for user access to the contents of the transport and dispensing device 100. As shown in FIGS. 1 and 2, in one option, a loading lug 114 is coupled to an outer surface of the front door 112. Referring again to FIG. 1, in yet another option, a container support, including a roller 116, is rotatably coupled to a proximal end of the base 106 adjacent the rear wall 110 of roll-off container body 104. The container support could, for example, include a sliding plate or runner. The roller 116 is coupled at an opposite position relative to the front door 112, in one option. As shown in FIGS. 6A, 6B, 7A and 7B, the transport and dispensing device 100 is lowered from a transport vehicle to an unloading position (FIG. 1) where the contents of the device 100 may be accessed. In one option, the transport and dispensing device 100 is lowered at an angle relative to the ground by a means of lowering, for example a winch having a cable or chain, coupled to the loading lug 114. FIGS. 6B and 7B illustrate the transport and dispensing device 100 as it is lowered by the transport vehicle cable and winch or hook lift (See FIG. 7B). The transport and dispensing device 100 slides on the base 106 and rolls on the roller 116 off the transport vehicle.

A ramp 118 is provided in one option (See FIGS. 1, 3 and 4). The ramp 118 is hingedly coupled to a distal end of the front door 112 along a proximal end of the ramp 118. In one option, the ramp is hingedly coupled to the front door 112 by a ‘piano’ type hinge. In order to lower and raise the door 112 and ramp 118, a door actuator mechanism 120 is provided, for example a winch having a moveable element 122, such as a cable or chain. In another option, the door actuator mechanism 120 and moveable element 122 include a hydraulic cylinder and piston or the winch is electrically driven. The door actuator mechanism 120 includes a mechanism body 124 coupled to a side wall 108 of the roll-off container body 104. The mechanism body 124, in one option, is welded to the side wall 108. In another option, the mechanism body 124 is bolted to the side wall 108. The moveable element 122 extends from the mechanism body 124 to a distal end of the ramp 118, where it is coupled thereto. The coupled element extends through a support member 126. The support member 126 extends from a side wall 108 perpendicularly to the base 106 of roll-off container body 104. In one option, the support member 126 includes a pulley to assist in advancement of the moveable element 122. In another option, the support member 126 includes a bearing to support the moveable element 122.

To withstand the rugged use of the transport and dispensing device 100 the front door 112, in one option, includes plate steel. The front door 112 is constructed from heavy duty materials to endure the pulling forces applied through the loading lug 114 due to the weight of the transport and dispensing device 100 and the contents held therein. In one option, the front door 112 is coupled to the container body base 106 by a steel ‘piano’ type hinge.

Referring again to FIG. 2, in another option, the loading lug 114 includes steel in its construction. The loading lug 114, in yet another option, is coupled to the front door 112 by a high strength weld capable of withstanding the pulling forces described above. Alternatively, in another option, the loading lug 114 is coupled to the front door 112 with a heavy duty nut and bolt assembly. In yet another option, the loading lug 112 is formed integrally with the front door 112.

As illustrated in FIG. 1, in one example, a door fastener, such as latching lugs 132 in one option, is provided that is coupled to the front door 112. A fastening member 130 is coupled to the container body side wall 108. The fastening member 130 is dimensioned and configured to operably engage the door fastener and thereby retain the front door 112 in a first, closed position (described below). The latching lugs 132 are coupled to the front door 112 in any one of a variety of methods. In one option, the latching lugs 132 are coupled by way of a strong weld between a steel front door 112 and steel latching lugs 132. In another option, the latching lugs 132 are coupled by heavy duty steel bolts and nuts received within the front door 112. In yet another option, the latching lugs 132 are integral to the front door 112. The fastening member 130 includes a shaft 134 disposed adjacent the side wall 108 and having a substantially vertical orientation with respect to the container body base 106. The shaft 134 is rotatably coupled to the side wall 108 and presents a handle 136, which extends orthogonally from the shaft 134. In one option, the shaft 134 is coupled to the side wall 108 with channel bearings to allow for rotation of the shaft 134 by the handle 136. Locking pins 138 are provided in one option that extend from the shaft 134 with an orientation orthogonal to the shaft 134 and handle 136. Each locking pin 138 is dimensioned and configured to operably engage one latching lug 132.

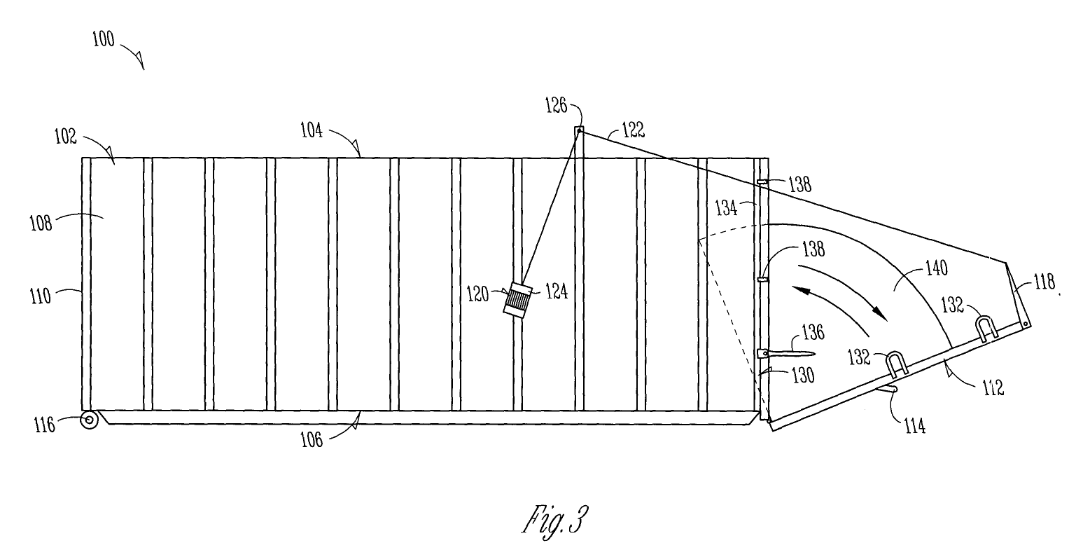

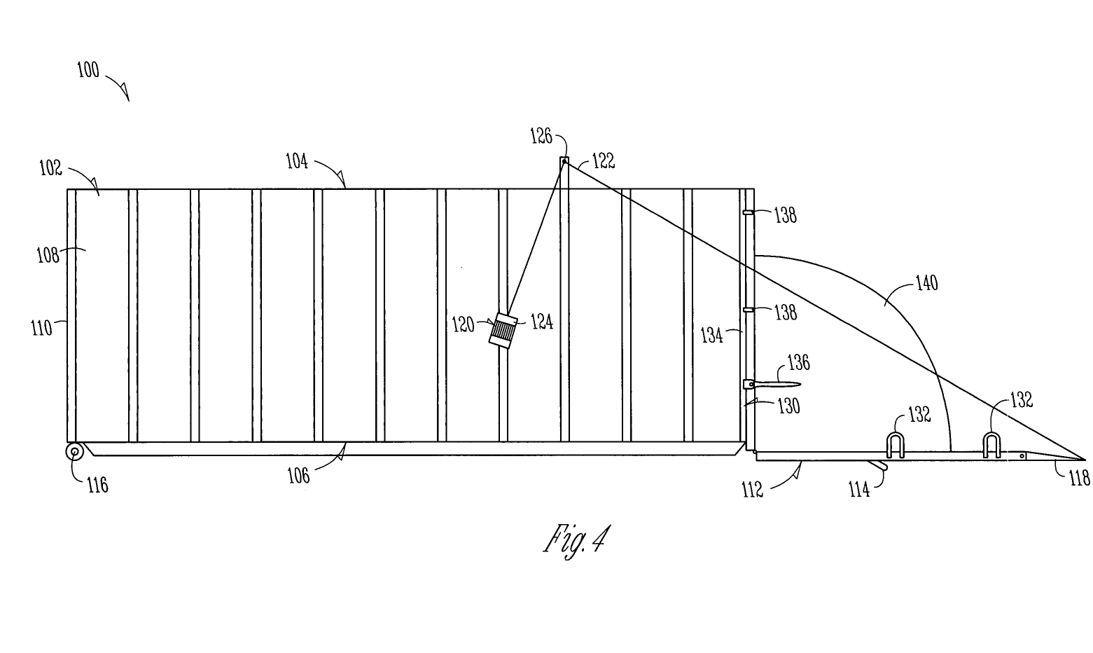

Spill shields 140, as shown in FIGS. 3 and 4 and in phantom lines in FIG. 1, are optionally provided on both sides of the front door 112 to prevent spilling of container contents from the sides of the front door 112. The spill shields are coupled to the front door 112. In one option, the spill shields are welded along the edges of door 112 so as not to interfere with movement of the door 112 by brushing against the side walls 108.

As shown in FIG. 1, the front door 112 is in a first, closed position. In one option, the front door 112 is substantially vertical with respect to the container body base 106, and the ramp 118 is substantially horizontal with respect to the container body base 106. In another option, the front door 112, in the first closed position, could be at an orientation having a substantially acute or obtuse angle with respect to the base 106. To open the transport and dispensing device 100, the handle 136 of the fastening member 130 is rotated from a first position, where the handle 136 has an orientation substantially parallel to the plane defined by side wall 108, to a second position where the handle 136 has an orientation substantially orthogonal to the plane defined by side wall 108. The rotation of the handle 136 measures roughly 90 degrees. Rotation of the handle 136 similarly rotates shaft 134 and the locking pins 138 coupled thereto. Rotation of the locking pins 138 moves the locking pins out of engagement with the latching lugs 132, thus freeing the front door 112 to open.

The door actuator mechanism 120, specifically the mechanism body 124 is operated to advance the moveable element 122 in the direction of the front door 112 where the moveable element 122 is coupled to the ramp 118. As illustrated in FIG. 3, with advancement of the moveable element 122, the front door 112 is lowered into a second, open position. As shown in FIG. 4, the front door comes to rest at an orientation substantially horizontal with respect to the container body base 106. The moveable element 122 continues to be advanced by mechanism body 124. In one option, ramp 118 is lowered into an orientation that is substantially horizontal with respect to the container body 106. In another option, ramp 118 is lowered into an orientation complementary to an orientation of a surface upon which the ramp 118 is disposed in the second, open position. In the second, open position, the spill shields 140 are disposed above the front door 112 and extend from the distal ends of the side walls 108 along the sides of the front door 112.

To close the transport and dispensing device 100, the steps for opening the device are repeated substantially in reverse. The moveable element 122 of the door actuator mechanism 120 is advanced oppositely from the direction used to lower the front door 112. The ramp 118 is pulled by the moveable element 122 from the complementary orientation (described above) in the second, open position to a substantially vertical orientation with respect to the container body base 106. The hinged coupling between the ramp 118 and the front door 112 includes stops that prevent the ramp 118 from traveling past the substantially vertical orientation. The mechanism body 124 continues to advance the moveable element 122 thereby pulling the ramp 118 and front door 112 into an intermediate position as shown in FIG. 3. The ramp 118 and front door 112 are then pulled into the first, closed position as shown in FIG. 1. The mechanism body 124 continues to exert tension on the ramp 118 and front door 112 to retain the door in the first, closed position. The handle 136 of fastening member 130 is rotated into a first position (described above). Rotating the handle 136 in turn rotates the shaft 138 and locking pins 138. The locking pins 138 are moved into engagement with the latching lugs 132. The engagement of the locking pins 138 retains the front door 112 and ramp 118 in the first, closed position. After the front door 112 and ramp 118 are secured by the locking pins 138 and latching lugs 132 the moveable element 122 may be loosened by the mechanism body 124. In another option, the moveable element 122 remains tensioned between the ramp 118 and the mechanism body 124 to provide further support to the locking pins 138 and latching lugs 132 when the transport and dispensing device 100 is loaded and unloaded from a transport vehicle.

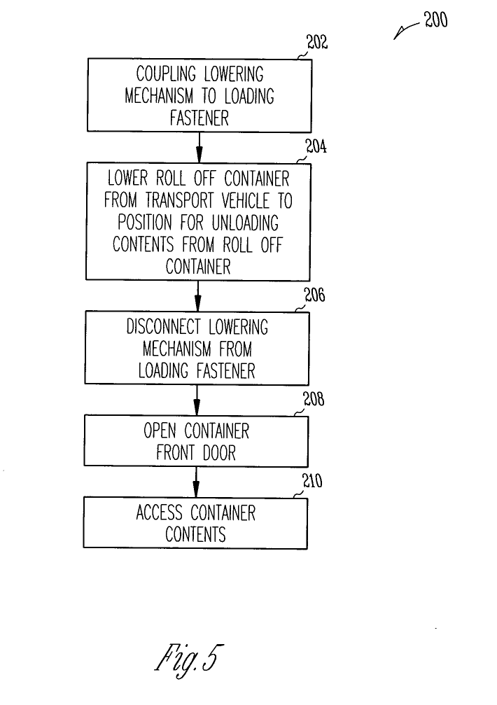

In another embodiment, principally illustrated in FIG. 5, a method 200 comprises first coupling a lowering mechanism, a winch for example, to a loading fastener coupled to a front door of a roll-off container. This step is shown principally in block 202. Next, the roll-off container is lowered from a transport vehicle to a position for unloading contents from the roll-off container. This step is shown principally in block 204. The roll-off container includes a roll-off container body defined by a base, side walls, and a rear wall. At least one roller is rotatably coupled to the container body. The at least one roller is preferably coupled adjacent the rear wall. The front door is coupled to the container body. The winch is then disconnected from the loading fastener as generally shown in block 206. The front door is then opened as is shown in block 208. The contents of the container may then be accessed as shown in block 210. Several options for the method follow. For example, in one option, the method 200 further includes positioning the roll-off container at a location for unloading contents from the roll-off container. Optionally, a rear wall of the roll-off container is positioned adjacent a boundary of the location, for example a property line or physical wall. In another option, the front door is hingedly coupled to a distal end of the roll-off container body base. In other words, the front door is hingedly coupled at an opposite end from the rear wall. Consequently, to open the front door, the front door is lowered from a first, closed position to a second, open position. In the first, closed position the front door has a substantially vertical orientation with respect to the roll-off container body base. In the second, open position the front door has a substantially horizontal orientation with respect to the container body base. In yet another option, the front door includes a ramp hingedly coupled to a distal end of the front door. When the door is lowered into the second, open position the ramp is in a substantially vertical position with respect to the roll-off container body base. The ramp is then lowered into an orientation complementary to an orientation of a surface upon which the ramp is disposed, for example a lawn or a parking lot. In still another option, a door actuator mechanism, such as a winch having a cable or chain is operated to lower and raise the front door as described above. Optionally, the door actuator mechanism is coupled at a first end to the roll-off container side wall and coupled at a second end to the ramp. The door actuator mechanism includes a hydraulic cylinder and piston, or the winch is electrically driven, in another option. In another option, the door is retained in the first, closed position by a door fastener coupled to the front door and operably engaged with a fastening member coupled to the roll-off container body side wall. To open the front door, the door fastener is released from its engagement with the fastening member. In one example, the door fastener is a latching lug engaged against rotatable locking pins coupled with a shaft and handle assembly. The handle is operated to rotate the locking pins out of engagement with the latching lug.

The transport and dispensing device and method allow for compact transport and storage of lawn and garden products, and allow for access of those products within tight space requirements. Because of the device design, a vehicle driver need only position the device within a space adequate for the roll-off container body. The provision of a front door disposed on an opposite end from the rear wall allows the driver to position the container without needing to consider a door when maneuvering the device into a position to unload the contents of the container. In other words, because the device door opens from the front, the direction the vehicle will pull away from the positioned device, the driver does not need to otherwise consider a door when maneuvering the device.

Additionally, because the door opens from the front end of the container body the driver may position the device with the rear wall and side walls adjacent the boundary of a location, for example, the boundary line of a property or another structure. The door may then be opened onto the property itself while the container body is adjacent the property boundary lines or other structures.

Furthermore, being able to move the transport and dispensing device provides easy access to an area of the property that would otherwise be inaccessible with a mound of mulch or other garden products occupying the area. Further still, the transport and dispensing device eliminates the need for separate bins constructed on the property as the device serves transport and storage needs.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope of the invention should, therefore, be determined with reference to the appended claims, along with the fill scope of equivalents to which such claims are entitled.

1. A transport and dispensing device, comprising:
a roll-off container body defined by a base, side walls, and a rear wall;
at least one container support coupled to the roll-off container body;
a front door coupled to the roll-off container body, the front door having a closed position and an open position, wherein the at least one container support is coupled to the roll-off container body at an opposed position relative to the front door; and
a loading fastener coupled to an outer surface of the front door.

2. The transport and dispensing device of claim 1, wherein the at least one container support is a roller rotatably coupled to a proximal end of the roll-off container body base.

3. The transport and dispensing device of claim 1, wherein the front door is hingedly coupled to a distal end of the roll-off container body base.

4. The transport and dispensing device of claim 1, further comprising:
a ramp hingedly coupled along a proximal end of the ramp to a distal end of the front door.

5. The transport and dispensing device of claim 4, wherein the front door has a substantially vertical orientation with respect to the container body base and the ramp has a substantially horizontal orientation with respect to the container body base when the front door is in the closed position.

6. The transport and dispensing device of claim 4, wherein the front door has a substantially horizontal orientation with respect to the container body base when the front door is in the open position.

7. The transport and dispensing device of claim 6, wherein the ramp has an orientation complementary to an orientation of a surface upon which the ramp is disposed when the front door is in the open position.

8. The transport and dispensing device of claim 4, further comprising:
a door actuating mechanism coupled to the roll-off container body, the mechanism including a moveable element extending from a mechanism body, wherein the moveable element is coupled to a distal end of the ramp.

9. The transport and dispensing device of claim 1, further comprising:
a vehicle, wherein the roll-off container body is removably disposed upon a surface of the vehicle.

10. A transport and dispensing device, comprising:
a roll-off container body defined by a base, side walls and a rear wall;
at least one container support coupled to the roll-off container body;
a front door including a door member coupled to the roll-off container body base, and further including a ramp coupled to a distal end of the door member, wherein the door member has a substantially vertical orientation with respect to the roll-off container body base and the ramp has a substantially horizontal orientation with respect to the roll-off container body base when the front door is in a first, closed position; and
a loading fastener coupled to an outer surface of the door member.

11. The transport and dispensing device of claim 10, wherein the at least one container support is a roller rotatably coupled to a proximal end of the roll-off container body base.

12. The transport and dispensing device of claim 10, wherein the door member is hingedly coupled to a distal end of the roll-off container body base.

13. The transport and dispensing device of claim 10, wherein the ramp is hingedly coupled to the distal end of the door member.

14. The transport and dispensing device of claim 10, wherein the door member has a substantially horizontal orientation with respect to the roll-off container body base and the ramp has an orientation complementary to an orientation of a surface upon which the ramp is disposed when the door is in a second, open position.

15. The transport and dispensing device of claim 10, further comprising:
a door actuator mechanism coupled to the roll-off container body, the mechanism including a moveable element extending from a mechanism body, wherein the moveable element is coupled to a distal end of the ramp.

16. A method comprising:
coupling a lowering mechanism to a loading fastener, the loading fastener coupled to a front door of a roll-off container;
lowering the roll-off container from a transport vehicle to a position for unloading contents from the roll-off container, the roll-off container body defined by a base, side walls and a rear wall, at least one roller rotatably coupled to the container body, and the front door coupled to the container body;
disconnecting the lowering mechanism from the loading fastener;
opening the front door; and
accessing contents inside the container.

17. The method of claim 16, further comprising:
positioning the roll-off container at a location for unloading contents from the roll-off container, wherein the rear wall of the roll-off container is positioned adjacent a boundary of the location.

18. The method of claim 16, wherein opening the front door further includes:
lowering the front door from a first, closed position having a substantially vertical orientation with respect to the roll-off container body base to a second, open position having a substantially horizontal orientation with respect to the roll-off container body base, wherein a proximal end of the front door is hingedly coupled to a distal end of the roll-off container body base.

19. The method of claim 18, wherein opening the front door further includes:
lowering a ramp from a substantially vertical position with respect to the roll-off container body base to a complementary position after the front door is lowered to the second, open position, wherein the ramp has an orientation complementary to an orientation of a surface upon which the ramp is disposed, the ramp is hingedly coupled along a proximal end of the ramp to a distal end of the front door.

20. The method of claim 19, wherein opening the front door further includes:
operating a door actuator mechanism to lower the front door from the first, closed position to the second open position, wherein the door actuator mechanism is coupled at a first end to the roll-off container side wall and coupled at a second end to a distal end of the ramp.

21. The method of claim 16, wherein opening the front door further includes:
releasing a door fastener coupled to the front door and operably engaged with a fastening member coupled to the roll-off container body side wall, wherein the door fastener is dimensioned and configured to retain the front door in a first, closed position.
